(19) United States
(12) Patent Application Publication
(10) Pub. No.: US 2004/0035371 A1
(43) Pub. Date: Feb. 26, 2004

(54) Nutrient and anti-microbial agent delivery method

(76) Inventor: Steven Tsengas, Fairport Harbor, OH (US)

Correspondence Address: Law Offices of John D. Gugliotta, PE, Esq., 202 Delaware Building, 137 South Main Street, Akron, OH, 44308, US

(21) Appl. No.: 10/611,821

(22) Filed: Jul. 1, 2003

Related U.S. Application Data
(60) Provisional application No. 60/393,071, filed on Jul. 2, 2002.

(51) Int. Cl. A01K 29/00

(52) U.S. Cl. 119/710

(57) ABSTRACT

A nutrient and anti-microbial delivery agent and method comprises a pet mastication article and the impregnation of nutrients, anti-microbial agents, flavoring and other suitable ingredients to enhance the flavor and healthy properties of the pet mastication article and effectively deliver desirable nutrients to a pet. The nutrients, anti-microbial agents, flavorings and other properties are impregnated by vacuum impregnation technology, wherein these agents and properties are effectively sealed into the pet mastication article and released upon use of the article by a pet.

### RELATED APPLICATIONS

The present application is a Non-Provisional Application claiming benefit of Provisional U.S. Patent Application Ser. No. 60/393,071, filed on Jul. 2, 2002.

### BACKGROUND OF THE INVENTION

1. Field of the Invention

The present invention relates generally to a method to produce an enriched raw bone and, specifically, to a vacuum sealing impregnation technology to add nutrients, flavoring, and/or anti-microbial agents to an object having micro-porosity, such as a raw bone or synthetic chewing object, intended for use by a domesticated animal, especially canines.

2. Description of the Related Art

The advent of new and improved technology has improved veterinary care and nutrition, sustaining and further increasing the life span of pets. However, with this longevity in life, it has become necessary for many pet owners to supplement their pets' nutritional needs and/or medicate their pets. The most common methods to administer nutritional supplements or medication is to provide pill-form vitamins, nutrition and/or medication. Most often, the pill must forced into the mouth of the pet or be hid in the pet's food to disguise the unpleasant taste and resulting chalkiness associated with pills. Each of these methods have proven to be difficult to perform, and often dangerous with a stubborn or difficult pet. As a result, many pet owners have sought an effective means of supplementing their pet's nutritional needs in a safe, efficient and pleasing manner.

A search of the prior art did not disclose any patents that read directly on the claims of the instant invention; however, the following references were considered related:

U.S. Pat. No. 1,149,170, issued in the name of Allis, discloses an animal toy made of a pliable material that is impregnated with a tasty substance along the exterior surface;

U.S. Pat. No. 3,891,334, issued in the name of Loikitz, discloses a pet chew toy formed from a polyamide substrate, such as NYLON®, wherein the substrate is formed into a shape that is attractive to a pet, such as a bone, and wherein the formed article is impregnated with flavor and odor properties by placement of the article into a pressure cooker containing the impregnation solution, the article being cooked at 210°-290° F. and at a pressure of 15-60 psi;

U.S. Pat. No. 4,674,444, issued in the name of Axelrod, discloses a pet chew toy having a layer of caramelized sugar impregnated onto the toy by immersing the toy into an aqueous solution of sugar and cooking at a temperature between 80°-300° C. and a pressure of 30 psi, and wherein the toy is manufactured from water absorbent nylon;

U.S. Pat. No. 5,897,893, issued in the name of Mohilef, discloses a pet chew with an edible tubular wrapper, and a method of making, wherein the chew toy has a bone core with an outer tubular wrapper placed around and shrinking to the bone core;

U.S. Pat. No. 5,912,285, issued in the name of Godsey, discloses a chew toy with a vegetable based flavoring and scent additive, wherein thermoplastic pellets is mixed with a vegetable based flavoring and scent additive and the toy is formed by injection molding; and

U.S. Pat. No. 6,178,922, issued in the name of Denesuk et al., discloses a tough chew resistant material in a shape that is attractive to a pet, wherein an anti-microbial agent is bound to the chew material.

Each of the aforementioned patents suffer from several shortcomings or drawbacks, including the failure to disclose a method for making a pet mastication product manufactured by vacuum impregnation of nutrients and anti-microbial agents. Vacuum impregnation of raw bones, in particular, is highly desirable because pets are attracted to such bones, thus a highly effective method of administering nutrients and anti-microbial agents is provided.

Consequently, there exists a continuous need for new ideas and enhancements for existing products in the pet mastication product industry.

### SUMMARY OF THE INVENTION

It is therefore an object of the present invention to provide a manner to impregnate raw bones with a nutrient and/or anti-microbial agent beneficial to the health of a pet.

It is another object of the present invention to provide a manner of adding nutrients, flavoring and/or anti-microbial agents to any object having micro-porosity.

It is a feature of the present invention to provide a manner to impregnate a raw bone with a nutrient, flavoring and/or anti-microbial agents.

Briefly described according to one embodiment of the present invention, a nutrient and anti-microbial delivery agent and method comprises a pet mastication article and the impregnation of nutrients, anti-microbial agents, flavoring and other suitable ingredients to enhance the flavor and healthy properties of the pet mastication article and effectively deliver desirable nutrients to a pet. The nutrients, anti-microbial agents, flavorings and other properties are impregnated by vacuum impregnation technology, wherein these agents and properties are effectively sealed into the pet mastication article and released upon use of the article by a pet.

### BRIEF DESCRIPTION OF THE DRAWINGS

There are no figures that accompany this specification.

### DESCRIPTION OF THE PREFERRED EMBODIMENTS

The best mode for carrying out the invention is presented in terms of its preferred embodiment described below.

A nutrient and anti-microbial agent delivery method comprises, generally, the nutrients, anti-microbial agents, flavor enhancements and other gustatory properties attractive to pets vacuum impregnated to a pet mastication article. It is envisioned that the pet mastication article may have a variety of forms, including bones, chew toys of varying styles, qualities, sizes and appearances, or other suitable articles used by pets for play and strengthening of teeth.

It is envisioned that a plurality of nutrients may be provided, including any or all of the vitamins and minerals required by the daily dietary proscriptions for particular breeds of pet. It is also envisioned that a plurality of combinations may be provided, including combinations sensitive to those pets susceptible to bladder stones caused by the over-absorption of dietary vitamins minerals, such as calcium and/or Vitamin C.

The pet mastication article includes anti-microbial agents provided to effectively combat microbial infestation that can cause illness and/or disease and contribute to overall degradation of the pet's health. A variety of anti-microbial agents may be provided, separately or in various combinations.

The pet mastication articles is impregnated with nutrients and other agents by vacuum impregnation. The pet mastication articles have a porous body, wherein the pores are open cell micro-porosity (on the order of between 3 and 10 microns). The body is manufactured from rubber, plastic or other similarly suitable materials ideal for micro-porosity and vacuum impregnation.

It is envisioned that a plurality of flavorings and other gustatory enhancements are available for use in combination with the pet mastication article and the nutrients and/or anti-microbial agents provided therein. The flavorings may include meat-based flavorings appealing to pets, or sweet tasting flavors also appealing to pets, such as peanut butter or various flavors of puddings or gelatins.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. A pet mastication article comprising:
a micro-porous body;
an enriching agent impregnated into said body.

2. The article of claim 1, wherein said body comprises a raw bone.

3. The article of claim 1, wherein said body comprises a synthetic bone manufactured from a material selected from the group consisting of plastic and rubber.

4. The article of claim 1, wherein said enriching agent is a dietary vitamin.

5. The article of claim 1, wherein said enriching agent is a dietary mineral.

6. The article of claim 1, wherein said enriching agent is an anti-microbial agent for combating microbial agents that cause illness and disease.

7. The article of claim 1, wherein said enriching agent is a flavor enhancer.

8. A method of producing a pet mastication article comprising the steps of:
a. selecting a pet mastication article of appropriate dimensions for a specified pet;
b. applying an enriching agent to said pet mastication article; and
c. vacuum sealing said enriching agent to said pet mastication article through micro-pores formed in said pet mastication article.

9. The method of claim 8, wherein said pet mastication article comprises a raw bone.

10. The method of claim 8, wherein said pet mastication article comprises a synthetic bone manufactured from a material selected from the group consisting of plastic and rubber.

11. The method of claim 8, wherein said enriching agent is a dietary vitamin.

12. The method of claim 8, wherein said enriching agent is a dietary mineral.

13. The method of claim 8, wherein said enriching agent is an anti-microbial agent for combating microbial agents that cause disease and illness.

14. The method of claim 8, wherein said enriching agent is a flavor enhancer.
